(19) United States
(12) Patent Application Publication
(10) Pub. No.: US 2013/0084182 A1
(43) Pub. Date: Apr. 4, 2013

(54) WIND ENERGY INSTALLATION AZIMUTH OR PITCH DRIVE

(71) Applicant: Jochen Röer, Ganderkesee (DE)

(72) Inventor: Jochen Röer, Ganderkesee (DE)

(73) Assignee: WOBBEN PROPERTIES GMBH, Aurich (DE)

(21) Appl. No.: 13/640,695

(22) PCT Filed: Apr. 11, 2011
(86) PCT No.: PCT/EP11/55625

§ 371 Date: Dec. 14, 2012

(30) Foreign Application Priority Data
Apr. 12, 2010 (DE) 10 2010 003 879.2

(51) Int. Cl. F03D 7/02

(52) U.S. Cl. CPC F03D 7/0224
USPC 416/1; 74/52; 416/147

(57) ABSTRACT

There is provided a wind power installation azimuth or pitch drive having a travelling wave drive.

### BACKGROUND

1. Technical Field

The present invention concerns a wind power installation azimuth or pitch drive.

2. Description of the Related Art

An azimuth drive or a pitch drive of a wind power installation typically has one or more electric motors. The electric motors are connected by way of first gears to second gears or pinions so that in the case of the azimuth drive, azimuth adjustment of the pod for wind direction tracking of the wind power installation is made possible by rotation of the motors. To avoid oscillations of the installation the control motors can be braced relative to each other. Alternatively the entire azimuth mounting can be fixed with a brake.

The known azimuth drives—like also known pitch drives—have a conventional gear-pinion combination which produces an unwanted play in the tooth arrangement. In addition such a tooth arrangement is subject to wear.

As general state of the art attention is described in patent applications DE 42 16 050 A1, DE 33 06 755 A1 and WO 01/86141 A1.

### BRIEF SUMMARY

One object of the present invention is to provide a wind power installation azimuth or pitch drive which has lesser play and a lower level of wear.

There is provided a wind power installation azimuth or pitch drive having a travelling wave drive.

In accordance with an aspect of the invention the travelling wave drive has an outer ring, an inner ring, a flexible ring provided at the inner ring and a plurality of linear drives at the periphery of the inner ring. The linear drives co-operate with the flexible ring and upon activation deform the flexible ring in such a way that the flexible ring at least temporarily locally lifts off the inner ring. Actuation of the linear drives is effected in such a way that the linear drives at the periphery of the inner ring are successively actuated.

In one embodiment of the present invention the flexible ring at least partially is of a wedge-shaped cross-section. The wedge-shaped portion of the flexible ring is braced in the inner ring and co-operates with the linear drives in such a way that upon actuation of the linear drives the flexible ring is locally pressed outwardly.

In one embodiment of the present invention the linear drive is actuated hydraulically or electrically.

In a further embodiment of the invention the drive optionally has a plurality of entrainment units along the periphery, which are respectively fixed to the flexible ring and the outer ring.

The invention also concerns a center-free drive comprising a travelling wave drive.

The invention also concerns a wind power installation comprising at least one above-described wind power installation azimuth or pitch drive.

Various embodiments of the invention are based on the notion of providing a travelling wave drive as the azimuth drive or the pitch drive of a wind power installation. Such a travelling wave drive does not have any tooth arrangement but for example an elastic ring in the form of a rotor, which is arranged concentrically relative to a stiff ring in the form of a stator. Radially arranged push rods and linear drives locally deform the elastic ring of the rotor in such a way that a wave circulates relative to the stator. Due to that flexing movement a relative movement occurs between the rotor and the stator and thus a rotational movement.

By virtue of the configuration of the travelling wave drive, the outer ring, the inner ring, the flexible ring as well as the linear drives, upon actuation of the linear drives (and in the co-operation of the linear drives with the flexible ring) the flexible ring can be of a slightly larger periphery than the inner ring. As a result the flexible ring can rotate relative to the inner ring (by the peripheral difference).

A travelling wave drive is advantageous as it can ensure a low rotary speed, a high level of rotational stiffness, freedom from play and a safeguard against overloading.

As an alternative to a wind power installation azimuth drive such a drive can also be used for other drives which run slowly and which have to transmit high levels of torque.

In addition a travelling wave drive according to the invention can be of a center-free configuration so that for example cables and/or fitters have access through the center to the entire drive as well as the adjoining accommodations. That drive can be used for driving or rotating weights of >1 t.

Aspects of the invention also concerns the use of a travelling wave drive as a drive for slowly running drives which apply high levels of torque.

### BRIEF DESCRIPTION OF THE SEVERAL VIEWS OF THE DRAWINGS

FIG. 1 shows a diagrammatic view of a travelling wave motor according to a first embodiment,

FIGS. 2A to 2C each show a diagrammatic view of a travelling wave motor in accordance with the first embodiment at different times,

FIG. 3 shows a perspective sectional view of a travelling wave motor in accordance with a second embodiment,

FIG. 4 shows a diagrammatic sectional view of a pressure generating unit for the travelling wave motor in accordance with the second embodiment,

FIG. 5 shows a diagrammatic sectional view of a travelling wave motor in accordance with a third embodiment, and

FIG. 6 shows a simplified view of a wind power installation having a partially sectioned pod.

### DETAILED DESCRIPTION

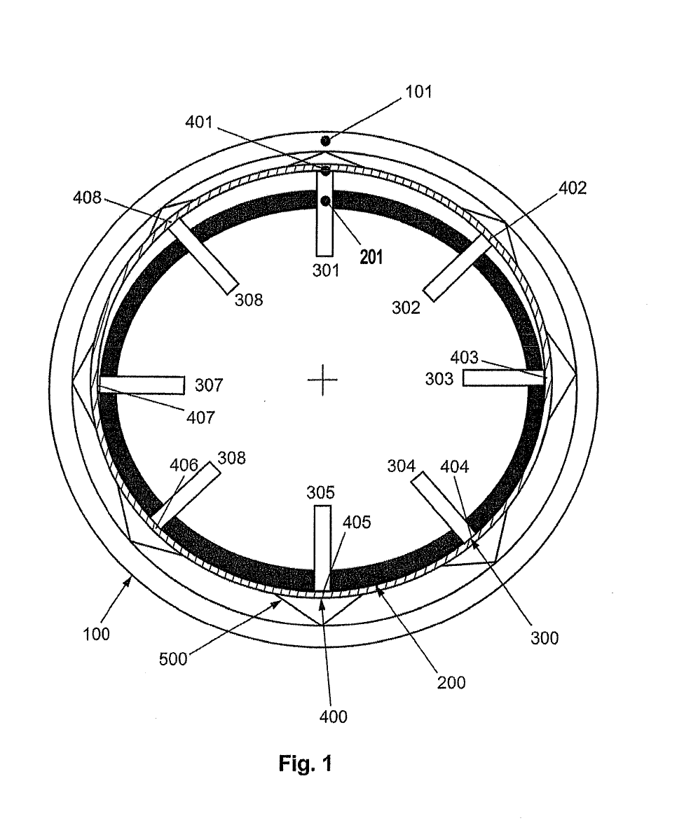

FIG. 1 shows a diagrammatic view of a travelling wave drive in accordance with a first embodiment. The travelling wave drive has an outer ring 100, an inner ring 200, a number of push rods or linear drives 300, a flexible ring or deformable ring 400 and optionally a plurality of entrainment portions 500 fixed to the flexible ring 400 and the outer ring 100. FIG. 1 shows eight push rods 301-308. The push rods can also be in the form of linear drives.

When the push rods or linear drives 300 are not actuated the flexible ring 400 bears against the inner ring 200 with sufficient force to hold or lock the flexible ring against the inner ring 200. The push rods or linear drives 301-308 are successively actuated so that the flexible ring or the entrainment locations 401-408 against which the push rods 301, 308 engage are pushed away locally from the inner ring 200 by actuation of the respective push rod or linear drive 300 or the flexible ring 400 is (locally) deformed at those locations. Because the push rods or linear drives 300-308 are actuated successively, the flexible ring is deformed at the points 401-402 at the periphery, in such a way that the deformed locations circulate in the form of a travelling wave relative to the stator, inner ring 200.

The outer ring 100 has a reference point 101, the inner ring 200 has a reference point 201 and the flexible ring 400 has a reference point 401. In FIG. 1 all three reference points 101, 201, 301 are shown in the twelve o'clock position. While the push rods or linear drives 303-307 are not activated, the push rods or linear drives 301, 302 and 308 may be activated or partially activated. The push rods or linear drives 300 are in contact with the flexible ring 400. Upon actuation of the push rods or linear drives 300, the flexible ring 400 can be deformed or pushed away from the inner ring 200, at least at some locations, so that at those locations the flexible ring 400 is no longer in contact (locally) with the inner ring 200.

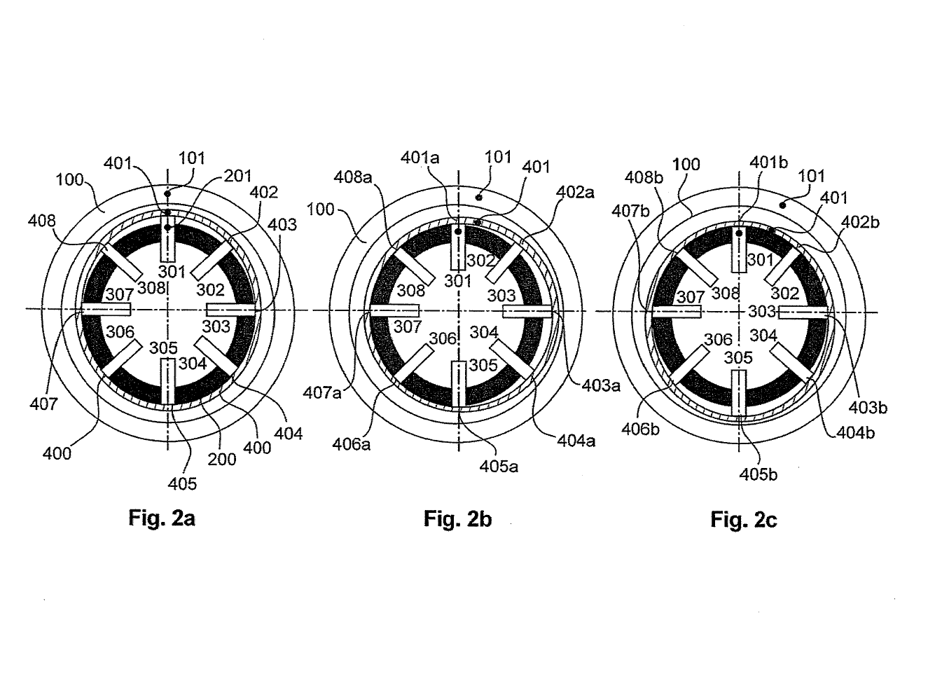

FIGS. 2A-2C each show a diagrammatic view of the travelling wave drive in accordance with the first embodiment. FIGS. 2A, 2B and 2C each show an outer ring 100, an inner ring 200, a flexring or flexible ring 400 and a plurality of push rods or linear drives 300. By activation of the individual push rods or linear drives 300, it is possible to act on the flexible ring 400 in such a way that the flexible ring is (locally) deformed at the engaged positions thereon and is thus released from the inner ring 200.

FIGS. 2A, 2B and 2C show three different moments in time during operation of the travelling wave drive in accordance with the first embodiment. The condition shown in FIG. 2A substantially corresponds to the condition shown in FIG. 1. In FIG. 2A the reference points 101, 201 and 401 are precisely at a twelve o'clock position. The outer ring 100 is stationary, the inner ring 200 is stationary and the travelling wave is also stationary.

FIG. 2B shows a moment in time at which the outer ring 100 has travelled through 11.25°. In this case the travelling wave has travelled for example through 90° and the inner ring 200 is stationary. Thus FIG. 2B shows a situation in which the reference points 101, 201 and 401 are no longer in the same position. While the push rods or linear drives 301, 302, 308 have been activated in the situation shown in FIG. 2A, in FIG. 2B the push rods or linear drives 302, 303 and 304 are activated. The push rods 301-308 now act at the second engagement points 401a-408a. Accordingly the points 401-408 have each travelled through 11.25° on the flexible ring 400.

FIG. 2C shows a further moment in time in the travel of the travelling wave. The push rods or linear drives 304-306 are now activated. The outer ring has travelled through 22.5° and the travelling wave through 180°. The push rods 301-308 thus respectively engage the engagement points 401b-408b.

It can thus be seen from FIGS. 2A-2C that the flexible ring travels in its position due to the deformation caused by activation of the push rods or linear drives.

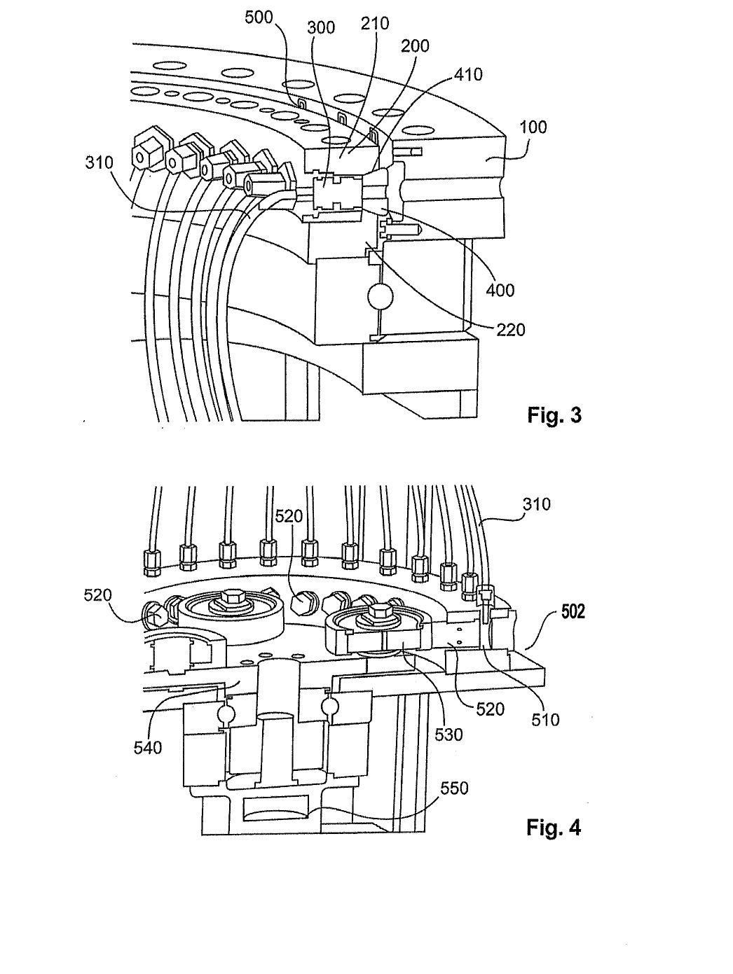

FIG. 3 shows a partial perspective sectional view of a travelling wave drive according to a second embodiment. The travelling wave drive has an outer ring or rotor 100, an inner ring or stator 200, a flexring or flexible ring 400 and a number of linear drives or push rods 300. The inner ring 200 and the flexible ring 400 are arranged concentrically with the outer ring 100. In the second embodiment the linear drives or push rods 300 are operated hydraulically. As an alternative thereto however other drives (for example electric drives) are also possible. For that purpose the linear drives or push rods 300 are connected to a hydraulic unit by way of a hydraulic line 310. Upon activation of the linear drives or push rods 300 (preferably in the radial direction) the flexible ring 400 is deformed at that location, that is to say it locally lifts off the inner ring 200. After deactivation of the push rods or linear drives 300 the deformation of the flexible ring is reversed again and there is once again contact or positive engagement between the flexible ring and the inner ring 200. The plurality of linear drives or push rods 400, provided in or at the inner ring 200, is preferably operated at a high switching frequency. Due to the wave in the flexible ring 400 it is of a slightly larger periphery than the inner ring 200. When the wave has circulated through a full revolution, the flexible ring 400 has turned relative to the inner ring through that difference in periphery. The entrainment portions 500 can transmit the rotary movement to the outer ring 100.

The flexible ring 400 is preferably of a wedge-shaped configuration in cross-section. The wedge-shaped portion 410 of the flexible ring 400 can be clamped in position or clamped fast for example by an upper and a lower portion 210, 220. That however should occur in such a way that deformation of the flexible ring in the radial direction is possible (with small stroke movements or deflection movements).

FIG. 4 shows a partial perspective sectional view of a pressure generating unit for the linear drives or push rods according to the second embodiment. The pressure generating unit 502 is connected by way of the hydraulic hoses 310 to the respective push rods or linear drives 300 (for example in accordance with the second embodiment). The pressure generating unit 502 has a multiplicity of push rods 520 which are respectively in operative communication with a volume 510 which in turn is in operative communication by way of the hydraulic hoses 310 with the push rods 300. The volume 510 is reduced by actuation of the push rods 520 so that the pressure within the hydraulic line 310 rises and the push rod or linear drive 300 at the end of the hydraulic hose 310 is actuated. The pressure generating unit further has a plurality of actuating units 530. For example there can be four actuating units 530. As an alternative thereto however more or fewer are also possible. The actuating units 530 can be arranged on a rotatable portion 540. That rotatable portion 540 can be driven by an electric motor 550. When the electric motor 550 drives the rotatable portion 540, the actuating units 530 will rotate and successively actuate the push rods 520 so that they are each urged inwardly and the volume 510 are thus compressed and the push rods or linear drives 300 are activated.

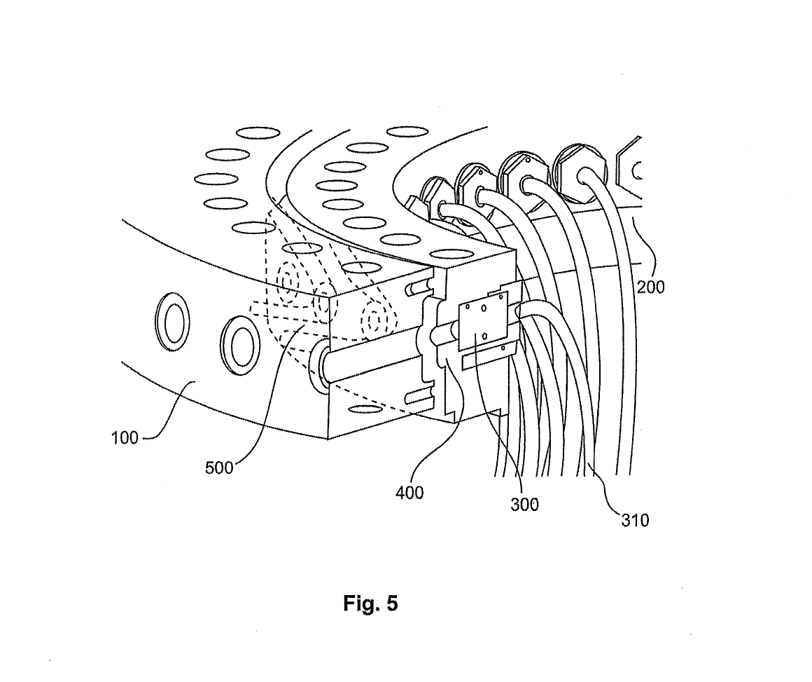

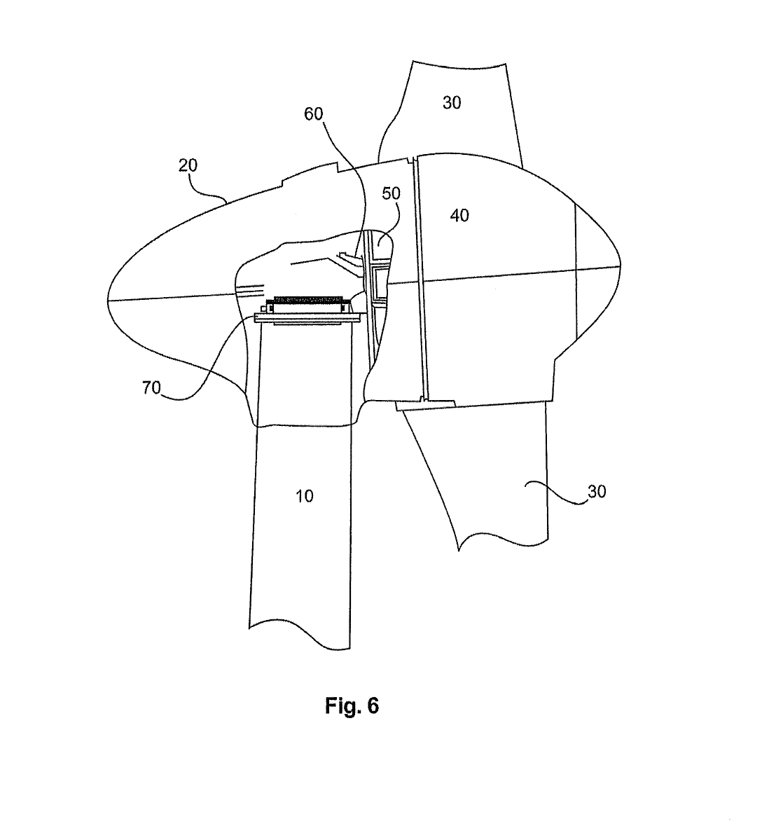

FIG. 5 shows a partial perspective sectional view of a travelling wave drive according to a third embodiment. In this case the travelling wave drive according to the third embodiment can be based on the travelling wave drive of the first or second embodiment. FIG. 5 shows in particular the structural unit of FIG. 3, except that in FIG. 5 the outer ring is shown as being semi-transparent. The travelling wave drive has an outer ring 100, an inner ring 200, a number of push rods or linear drives 300 and a flexible ring 400, as well as a number of entrainment portions 500. The push rods 300 are connected for example to a pressure generating unit by way of hydraulic lines 310 so that the push rods or linear drives 300 are successively activated so that they at least temporarily deform the flexible ring 400 at that location and locally lift it off the inner ring so that this produces a travelling wave. The flexible ring 400 is coupled to the outer ring 100 by means of the entrainment portions 500. Those entrainment portions can be for example of a V-shaped configuration, wherein the two free ends can be fixed to the outer ring 100 while the pointed end can be fixed to the flexible ring 400. As an alternative thereto other configurations are also possible for the entrainment portion. Thus the entrainment portion 500 can for example also be in the form of a rod.

FIG. 6 shows a simplified view of a wind power installation with a partly sectioned pod. The wind power installation has a pylon 10, a pod 20 mounted thereon, at least one rotor blade 30, a hub 40, a generator 50 and a machine carrier 60. The machine carrier 60 is mounted on the head of the pylon 10 rotatably by an azimuth drive 70. The azimuth drive 70 serves for azimuth tracking or wind direction tracking for the pod. The pod together with the machine carrier can be displaced by the azimuth drive or the wind direction tracking in such a way that the rotor blades are always disposed at an optimum angle relative to the main direction of the wind. The azimuth drive 70 of the wind power installation shown in FIG. 6 can be in the form of a travelling wave drive in accordance with the first, second or third embodiment.

The above-described travelling wave drives can be implemented or used for example in an azimuth drive or a pitch drive of a wind power installation. Alternatively the travelling wave drive according to the invention can also be used in relation to other drives. In particular the travelling wave drive can be implemented or used in a center-free, slowly rotating drive.

The various embodiments described above can be combined to provide further embodiments. All of the U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wind power installation azimuth or pitch drive comprising:
a travelling wave drive that includes an outer ring, an inner ring, and a flexible ring located between the outer ring and the inner ring, the travelling wave drive further including a plurality of linear drives abutting a surface of the flexible ring, each of the linear drives being configured to selectively deform the flexible ring upon activation.

2. The wind power installation azimuth or pitch drive according to claim 1 wherein each of the linear drives temporarily lifts at least a portion of the flexible ring off the inner ring upon activation.

3. The wind power installation azimuth or pitch drive according to claim 1 wherein the flexible ring has at least a portion that has a wedge-shaped cross-section that rests against the inner ring and co-operates with the linear drives in such a way that upon actuation of the linear drives the flexible ring is locally pressed outwardly.

4. The wind power installation azimuth or pitch drive according to claim 1 wherein the linear drives are actuated hydraulically.

5. The wind power installation azimuth or pitch drive according to claim 1 wherein a plurality of entrainment units are arranged along a periphery of the flexible ring and are respectively fixed to the flexible ring and to the outer ring, wherein the entrainment units are configured to transmit rotary movement of the flexible ring to the outer ring.

6. The wind power installation azimuth or pitch drive according to claim 1 wherein the inner ring has a central opening.

7. A wind power installation comprising:
a pylon;
a pod located on the pylon, the pod including a rotor hub and at least one rotor blade coupled to the rotor hub; and
a machine carrier located on a surface of the pylon, the machine carrier being rotatably coupled to an azimuth drive, the azimuth drive including an outer ring, an inner ring, and a flexible ring located between the outer ring and the inner ring, the azimuth drive further including a plurality of linear drives abutting a surface of the flexible ring, each of the linear drives being configured to selectively deform the flexible ring upon activation, the azimuth drive being configured to rotate at least one of the machine carrier and the pod.

8. (canceled)

9. The wind power installation according to claim 7 wherein the azimuth drive is configured to actuate each of the linear drives successively.

10. The wind power installation according to claim 7 wherein the linear drives are hydraulically actuated.

11. The wind power installation according to claim 7 wherein the inner ring has a central opening.

12. The wind power installation azimuth or pitch drive according to claim 2 wherein each of the linear drives is actuated successively.

13. The wind power installation azimuth or pitch drive according to claim 12 wherein successive activation of each of the linear drives causes the flexible ring to rotate relative to the inner ring.

14. A method comprising:
actuating a first driver to cause a first portion of a flexible ring to lift off of an inner ring; and
actuating a second driver to cause a second portion of the flexible ring to lift off of the inner ring, the first and second drivers begin actuation successively, and wherein actuating the first and second drivers further causes an outer ring to rotate relative to the inner ring, wherein the rotating the outer ring causes at least one of a pod and a rotor blade of a wind power installation to rotate.

15. The method according to claim 14 wherein actuating the first and second drivers includes linearly actuating the first and second drivers.

16. The method according to claim 14 wherein the first and second drivers are hydraulically actuated.

17. A wind power installation comprising:
a travelling wave drive that includes an outer ring concentric with an inner ring, and a flexible ring located between the outer ring and the inner ring, the travelling wave drive further including a plurality of linear drives that when successively activated are configured rotate the outer ring relative to the inner ring.

18. The wind power installation according to claim 17 wherein the travelling wave drive is an azimuth drive configured to rotate a pod of the wind power installation.

19. The wind power installation according to claim 17 wherein the travelling wave drive is a pitch drive configured to rotate a rotor blade of the wind power installation.

20. The wind power installation according to claim 17 wherein the plurality of linear drives are configured to deform a portion of the flexible ring upon activation.
